(19) United States
(12) Patent Application Publication
(10) Pub. No.: US 2009/0083048 A1
(43) Pub. Date: Mar. 26, 2009

(54) SYSTEM AND METHOD FOR PROVIDING AN APPLICATION SERVICE

(76) Inventors: Steven J. Mandelbaum, Washington, DC (US); Philip H. Meisner, Hawthorne, NJ (US)

Correspondence Address: PILLSBURY WINTHROP SHAW PITTMAN, LLP, P.O. BOX 10500, MCLEAN, VA, 22102, US

(21) Appl. No.: 11/859,417

(22) Filed: Sep. 21, 2007

(51) Int. Cl. G06Q 50/00

(52) U.S. Cl. 705/1

(57) ABSTRACT

Systems and methods for providing an efficient application service is provided. The systems and methods may include one or more hardware and/or software modules that may receive one or more application datasets from an applicant to forward to one or more of a plurality of application recipients. One or more third parties (such as high school guidance counselors, employment service counselors, and other third parties) may help mediate the process by acting on behalf of the applicant and/or on behalf of the one or more of a plurality of application recipients. The application service may also issue to the applicant one or more tokens that may be assigned by the applicant to the one or more of a plurality of application recipients. The one or more tokens may indicate a level of interest by the applicant in the one or more of a plurality of application recipients. The application service may also send sampler applications, or portions of an application including at least one of the one or more datasets, to one or more of a plurality of application recipients, including application recipients that do not have a pre-existing business relationship with the application service. Using certain aspects of the invention, the applicant may more efficiently submit applications using a single point of entry. Furthermore, application recipients may increase the proportion of offers accepted by the applicant compared to the number of offers made as well as efficiently increase pools of applicants without the cost of pre-existing contracts.

### FIELD OF THE INVENTION

This invention relates to systems and methods to provide a streamlined and efficient application service.

### BACKGROUND OF THE INVENTION

The application process for school admissions or employment opportunities results in duplicative and inefficient effort. Conventional systems and methods of application processes fail to address these problems because accessing information and data using conventional systems and methods is often slow, inaccurate, and incomplete. This is true whether applications are processed using traditional paper applications, electronic applications, or other conventional application system and method. Research indicates that colleges, for example, routinely look to improve the volume and quality of their application pool in an effort to recruit better-qualified students to matriculate. However, because each applicant must often apply to each college to conform to mainly format deviations of the requested information, resulting in wasted time and effort on the part of the applicant. This may discourage the applicant from applying to institutions to which the applicant would have applied. As a result, many colleges may face smaller pools of applicants than they desire and many applicants spend too much time on the application process.

Even if colleges, for example, receive an adequate quantity of applications, they may struggle to benchmark and compare applications and detect which students will ultimately matriculate if accepted. Indicating interest by the applicant using conventional methods, such as, for example, writing special essays, making site visits and even gathering special recommendations from influential alumni, are only a rough proxy for actual interest. Conventional systems and methods provide little predictability into whether an applicant will accept an offer. Besides, many applicants may not be able to afford the expense of these processes.

### SUMMARY OF THE INVENTION

The invention relates to various systems and methods for providing an application service. One implementation of the invention may include one or more hardware and/or software application service modules that may receive one or more application datasets from applicants and may forward the one or more application datasets to one or more of a plurality of application recipients. Application datasets may include data related to an applicant such as, for example, grades, test scores, essays, letters of recommendation, references, and/or other data related to an applicant. In some implementations, the invention may include one or more hardware and/or software modules that may issue to the applicant one or more tokens, wherein the applicant may assign the one or more tokens to one or more of the plurality of application recipients. The assigned one or more tokens may indicate a level of interest by the applicant in the one or more of the plurality of application recipients.

In some implementations, the application recipient module may include one or more hardware and/or software modules such as, for example, an application recipient controller module, an application recipient dataset handler module, a status update module, an application recipient report module, and/or any other modules. The application recipient controller module may use the application recipient dataset handler module for interactions with the one or more application datasets including, for example, receive, download, process, and/or other interactions with the one or more application datasets. The application recipient controller module may use the status update module to update application status. Application status may include status indicators such as, for example, received, processing, considering, and/or any other status indicators. The application recipient module may use the application recipient report module to generate one or more reports for one or more of the plurality of application recipients. Reports may include application information based on any grouping of applicants such as, for example, a particular applicant, applicants based on a locality, applicants nationwide, and/or any other grouping of applicants. Reported application information may include any information such as, for example, test scores, grades, prior experience, and/or any other application information.

In some implementations, the applicant module may include one or more hardware and/or software modules such as, for example, an applicant controller module, an applicant dataset handler module, a token handler module, an applicant report module, and/or other modules. The applicant controller module may, for example, control modules and functions related to applicant interaction with the system and other functions. For example, the applicant controller module may use the applicant dataset handler module to handle the one or more application datasets including, for example, receiving, processing, storing, and/or performing any other application dataset handling functions on the one or more application datasets.

In some implementations, the applicant controller module may use the token handler module to perform functions related to applicant tokens, including, for example, issuing tokens, keeping track of assigned tokens, returning tokens, and/or any other function related to applicant tokens.

In some implementations, the applicant controller module may use the applicant report module to generate reports for the applicant such as, for example, status update reports, application dataset reports, account balance reports, payment history reports, token reports, and/or any other reports for the applicant.

In some implementations, the third party module may include other hardware and/or software modules such as, for example, a third party controller module, a third party application dataset handler module, a tracker module, a third party report module, and/or other modules. The third party controller module may use the application dataset handler module to provide functions to the third party to handle application datasets on behalf of the applicant. A third party may include, for example, a high school guidance counselor acting on behalf of a college applicant, an employment service acting on behalf of a job seeker, and/or any other third party acting on behalf of the applicant. The third party controller module may use the tracker module to provide functions to track the applicant. Tracking may include, for example, identifying applicants for which the third party will act, listing applicants for which the third party will act, and/or any other tracking functions. In response to a request to generate a report, the third party controller module may use the third party report module to generate reports to the third party. Reports may include, for example, applicant progress reports, applicant summary reports, and/or any other report.

In some implementations, the payment module may facilitate payments to the application service. Payments may be made by any user such as, for example, an applicant, one or more third parties, one or more of the plurality of application recipients, and/or any other user. Payments due may include, for example, registration fees, application fees, and/or any other payment due. Furthermore, the application service may accept application fees due to the application recipient on behalf of the application recipient.

In some implementations, the request handler module may handle requests made by any user. Requests may be made by any user to any other user, any user to the system, the system to any user, or any other request combination. Requests may include, for example, an update status request, a request for one or more datasets, a request to cancel an application, and/or any other request. If a request is made by one user to another user, for example, the request handler module may notify the appropriate user of the request.

In some implementations, the data aggregator module may aggregate data related to the application from a variety of sources including, for example, blogs, message boards, chat sessions, forums, and/or any or source. As used herein, data related to the application may include any data such as, for example, peer impressions of application recipients, personal statements by applicants, and/or any other data related to the application.

In some implementations, the one or more servers may provide a website accessed by the one or more clients. The website may be generated through the one or more user interface modules using the one or more application service modules running on the one or more servers.

In some implementations, the application service may receive registrations from one or more of the plurality of application recipients (i.e., the plurality of application recipients may register with the application service to receive the one or more application datasets). For example, colleges, universities, employers, and/or others, may register with the application service through a website, for example, to be able to receive the one or more application datasets from high school students, job seekers, and/or other applicants. The applicant may use the user interface to register to use the application service. The applicant may upload one or more application datasets using the website. The applicant may be presented with a selection of the plurality of application recipients that have registered to use the application service.

The applicant may also be issued one or more tokens that indicate a level of interest in one or more of the plurality of application recipients. The applicant may make selections of one or more of the plurality of application recipients. The applicant may assign one or more of the tokens to one or more of the plurality of application recipients. The application service may notify each of the selected one or more of the plurality of application recipients to which the applicant has applied. The notification may include instruction on how to download the one or more application datasets, the number of tokens assigned by the applicant, the number of tokens issued to the applicant (for example, a greater proportion of assigned-to-issued tokens may indicate a higher level of interest in the application recipient), and/or any other notification.

In some implementations, each of the selected one or more of the plurality of application recipients may update the progress of the application. Upon receipt of the update notification, the application service may notify the applicant of such update. Furthermore, each of the selected one or more of the plurality of application recipients may request further information. For example, the request may include requests to supply additional letters of recommendation, request for personal interview, and/or any other request. The applicant may also make requests, such as, for example, request to update status, request to withdraw the application, and/or any other request.

Furthermore, in some implementations, the applicant may control access to the application. The application service may, through the access control module, allow the applicant to identify one or more third parties to access the application. For example, the applicant may identify a high school guidance counselor to be able to access the application in order to help mediate the process. The third party that was given access may, at least in part based on the applicant access controls, update, view, monitor, upload, provide comments, and/or perform any other access function regarding the application. Throughout the process, the application service may also aggregate data relevant to the application from a plurality of data sources to provide users with additional information that may be relevant to the application. The plurality of sources may include, for example, web logs (“blogs”), online polls, message boards, and/or any other source.

In some implementations, the application service may present one or more of the plurality of application recipients with a sampler application. A sampler application may include a portion of the application, including one or more application datasets. One or more of the plurality of application recipients that may be presented with a sampler application may include, for example, those that do not have a pre-existing business relationship with the application service, those that have registered with the application service in the past, those that have subscription-based services (those that do have a pre-existing business relationship), and/or other application recipient. One or more of the plurality of application recipients that were presented with a sampler application may fully “purchase” any one of the one or more applications on an ad-hoc basis. Purchasing sampler applications may include other payment options, such as, for example, on a subscription basis. Subscriptions may include, for example, receiving full applications of a set number of sampler applications, receiving full applications of sampler applications for a specified period of time, and/or any other subscription.

In some implementations, the invention may include a method for providing a sampler application of an applicant to one of a plurality of application recipients, the sampler application including only a portion of a full application and not the full application, the full application including one or more application datasets, the method comprising receiving one or more application dataset, providing the applicant with information identifying a plurality of application recipients, from which the applicant may select one or more of the plurality of application recipients to which to apply, receiving from the applicant a selection of one or more of the plurality of application recipients to which the applicant wishes to apply, and providing the selected one or more of the plurality of application recipients the sampler application.

In some implementations, the invention may include a method further comprising receiving an election from a responding one of the selected one or more of the plurality of application recipients to receive further information regarding the applicant, providing the responding one of the selected one or more of the plurality of application recipients with at least an additional portion of the full application, and notifying the applicant of the election and the provision of the at least an additional portion of the full application.

In some implementations, the invention may include a method further comprising initiating a sampler application bounceback, the sampler application bounceback indicating that the selected one or more of the plurality of application recipients has not elected to receive at least an additional portion of the full version of the sampler application, and notifying the applicant of the sampler application bounceback.

In some implementations, the invention may include a method wherein the sampler application bounceback resulted from an expiration of a sampler period, wherein the sampler period is a period of time within which the selected one or more of the plurality of application recipients must elect to receive at least an additional portion of the full application.

In some implementations, the invention may include a method wherein the sampler application bounceback resulted from the selected one or more of the plurality of application recipients actively indicating no interest in receiving at least an additional portion of the full version of the sampler application.

In some implementations, the invention may include a method further comprising allotting the applicant one or more tokens, the one or more tokens being associated with a level of interest in one or more of the plurality of application recipients, receiving from the applicant an assignment of a number of the one or more tokens to a particular one of the one or more of the plurality of application recipients, and providing the particular one of the one or more of the plurality of application recipients information related to the assignment of the number of the one or more tokens that were assigned by the applicant to the particular one of the one or more of the plurality of application recipients.

In some implementations, the invention may include a method providing the particular one of the one or more of the plurality of application recipients with the number of the one or more tokens allotted to the applicant. In some implementations, the invention may include a method further comprising allotting the applicant one or more super-tokens, the one or more super-tokens being associated with an enhanced level of interest in one or more of the plurality of application recipients as compared to the one or more tokens, receiving from the applicant a second assignment of a second number of one or more super-tokens to a particular one of the one or more of the plurality of application recipients, and providing the particular one of the one or more of the plurality of application recipients information related to the second number of the one or more super-tokens that were assigned by the applicant to the selected one or more of the plurality of application recipients and the allotted super-tokens.

In some implementations, the invention further includes a method further comprising providing the particular one of the one or more of the plurality of application recipients with the second number of the one or more super-tokens allotted to the applicant.

In some implementations, the invention may include a method further comprising in response to an indication of rejection by the selected one or more of the plurality of application recipients: notifying the applicant of the indication of rejection, and returning to the applicant the one or more tokens assigned to the selected one or more of the plurality of application recipients that gave the indication of rejection. In some implementations, the invention may include a method wherein the returned one or more tokens may be reassigned by the applicant to another one of the one or more of the plurality of application recipients.

In some implementations, the invention may include a method wherein the plurality of application recipients are educational institutions. In some implementations, the invention may include a method wherein the educational institutions are undergraduate universities. In some implementations, the invention may include a method wherein a pre-existing business relationship does not exist between one or more of the plurality of application recipients and a provider of the application.

In some implementations, the invention may include a method wherein the one or more application datasets is submitted by the applicant. In some implementations, the invention may include a method wherein the one or more application datasets is submitted by a third party. In some implementations, the invention may include a method wherein the third party is associated with the applicant. In some implementations, the invention may include a method wherein the third party is associated with one or more of the plurality of application recipients. In some implementations, the invention may include a method wherein the plurality of application recipients are prospective employers.

In some implementations, the invention may include a method wherein the plurality of application recipients are prospective employees. In some implementations, the invention may include a method wherein a pre-existing business relationship does not exist between the applicant and a provider of the application.

In some implementations, the invention may include a computer readable medium containing computer-executable instructions for providing a sampler application of an applicant to one of a plurality of application recipients, the sampler application including only a portion of a full application and not the full application, the full application including one or more application datasets, the instructions operable when executed on a computing device to receive one or more application dataset, provide the applicant with information identifying a plurality of application recipients, from which the applicant may select one or more of the plurality of application recipients to which to apply, receive from the applicant a selection of one or more of the plurality of application recipients to which the applicant wishes to apply, and provide the selected one or more of the plurality of application recipients the sampler application.

In some implementations, the invention may include a computer readable medium containing computer-executable instructions, the instructions further operable when executed on a computing device to receive an election from a responding one of the selected one or more of the plurality of application recipients to receive further information regarding the applicant, provide the responding one of the selected one or more of the plurality of application recipients with at least an additional portion of the full application, and notify the applicant of the election and the provision of the at least an additional portion of the full application.

In some implementations, the invention may include a computer readable medium containing computer-executable instructions, the instructions further operable when executed on a computing device to initiate a sampler application bounceback, the sampler application bounceback indicating that the selected one or more of the plurality of application recipients has not elected to receive at least an additional portion of the full version of the sampler application, and notify the applicant of the sampler application bounceback.

In some implementations, the invention may include a computer readable medium containing computer-executable instructions, wherein the sampler application bounceback resulted from an expiration of a sampler period, wherein the sampler period is a period of time within which the selected one or more of the plurality of application recipients must elect to receive at least an additional portion of the full application.

In some implementations, the invention may include a computer readable medium containing computer-executable instructions, wherein the sampler application bounceback resulted from the selected one or more of the plurality of application recipients actively indicating no interest in receiving at least an additional portion of the full version of the sampler application. In some implementations, the invention may include a computer readable medium containing computer-executable instructions, the instructions further operable when executed on a computing device to allot the applicant one or more tokens, the one or more tokens being associated with a level of interest in one or more of the plurality of application recipients, receive from the applicant an assignment of a number of the one or more tokens to a particular one of the one or more of the plurality of application recipients, and provide the particular one of the one or more of the plurality of application recipients information related to the assignment of the number of the one or more tokens that were assigned by the applicant to the particular one of the one or more of the plurality of application recipients.

In some implementations, the invention may include a computer readable medium containing computer-executable instructions, the instructions further operable when executed on a computing device to provide the particular one of the one or more of the plurality of application recipients with the number of the one or more tokens allotted to the applicant. In some implementations, the invention may include a computer readable medium containing computer-executable instructions, the instructions further operable when executed on a computing device to allot the applicant one or more super-tokens, the one or more super-tokens being associated with an enhanced level of interest in one or more of the plurality of application recipients as compared to the one or more tokens, receive from the applicant a second assignment of a second number of one or more super-tokens to a particular one of the one or more of the plurality of application recipients, and provide the particular one of the one or more of the plurality of application recipients information related to the second number of the one or more super-tokens that were assigned by the applicant to the selected one or more of the plurality of application recipients and the allotted super-tokens.

In some implementations, the invention may include a computer readable medium containing computer-executable instructions, the instructions further operable when executed on a computing device to providing the particular one of the one or more of the plurality of application recipients with the second number of the one or more super-tokens allotted to the applicant. In some implementations, the invention may include a computer readable medium containing computer-executable instructions, the instructions further operable when executed on a computing device to: in response to an indication of rejection by the selected one or more of the plurality of application recipients notify the applicant of the indication of rejection, and return to the applicant the one or more tokens assigned to the selected one or more of the plurality of application recipients that gave the indication of rejection.

In some implementations, the invention may include a computer readable medium containing computer-executable instructions, wherein the returned one or more tokens may be reassigned by the applicant to another one of the one or more of the plurality of application recipients. In some implementations, the invention may include a computer readable medium containing computer-executable instructions, wherein the plurality of application recipients are educational institutions. In some implementations, the invention may include a computer readable medium containing computer-executable instructions, wherein the educational institutions are undergraduate universities. In some implementations, the invention may include a computer readable medium containing computer-executable instructions, wherein the plurality of application recipients are undergraduate universities.

In some implementations, the invention may include a computer readable medium containing computer-executable instructions, wherein a pre-existing business relationship does not exist between one or more of the plurality of application recipients and a provider of the application. In some implementations, the invention may include a computer readable medium containing computer-executable instructions, wherein the one or more application datasets is submitted by the applicant. In some implementations, the invention may include a computer readable medium containing computer-executable instructions, wherein the one or more application datasets is submitted by a third party. In some implementations, the invention may include a computer readable medium containing computer-executable instructions, wherein the third party is associated with the applicant. In some implementations, the invention may include a computer readable medium containing computer-executable instructions, wherein the third party is associated with one or more of the plurality of application recipients.

In some implementations, the invention may include a computer readable medium containing computer-executable instructions, wherein the plurality of application recipients are prospective employers. In some implementations, the invention may include a computer readable medium containing computer-executable instructions, wherein the plurality of application recipients are prospective employees. In some implementations, the invention may include a computer readable medium containing computer-executable instructions, wherein a pre-existing business relationship does not exist between the applicant and provider of the application.

In some implementations, the invention may include a computer readable medium containing computer-executable instructions, the instructions further operable when executed on a computing device to aggregate data associated with the selected one or more of the plurality of application recipients, and present the aggregated data to the applicant.

In some implementations, the invention may include a method for providing an interest rating of an applicant in one or more of a plurality of application recipients and an application of the applicant to the one of the plurality of application recipients, the application including one or more application datasets, the method comprising receiving one or more application datasets, providing the applicant with information identifying a plurality of application recipients, from which the applicant may select one or more of the plurality of application recipients to which to apply, allotting the applicant one or more tokens, the one or more tokens being associated with a level of interest in one or more of the plurality of application recipients, receiving from the applicant a selection of one or more of the plurality of application recipients to which the applicant wishes to apply, receiving from the applicant an assignment of a number of the one or more tokens to a particular one of the one or more of the plurality of application recipients, providing the particular one of the one or more of the plurality of application recipients information related to the assignment of the number of the one or more tokens that were assigned by the applicant to the particular one of the one or more of the plurality of application recipients, and providing the application to the selected one or more of the plurality of application recipients.

In some implementations, the invention may include a method further comprising providing the particular one of the one or more of the plurality of application recipients with the number of the one or more tokens allotted to the applicant. In some implementations, the invention may include a method further comprising allotting the applicant one or more super-tokens, the one or more super-tokens being associated with an enhanced level of interest in one or more of the plurality of application recipients as compared to the one or more tokens, receiving from the applicant an assignment of a second number of the one or more super-tokens to a particular one of the one or more of the plurality of application recipients, and providing the particular one of the one or more of the plurality of application recipients information related to the assignment of the second number of the one or more super-tokens that were assigned by the applicant to the particular one of the one or more of the plurality of application recipients.

In some implementations, the invention may include a method further comprising providing the particular one of the one or more of the plurality of application recipients with the second number of the one or more super-tokens allotted to the applicant. In some implementations, the invention may include a method further comprising in response to an indication of rejection by the selected one or more of the plurality of application recipients: notifying the applicant of the indication of rejection, and returning to the applicant the one or more tokens assigned to the selected one of the plurality of application recipients that gave the indication of rejection.

In some implementations, the invention may include a method wherein the returned one or more tokens may be reassigned by the applicant to a another one of the selected one of the plurality of application recipients. In some implementations, the invention may include a method wherein the provided application is a sampler application, the sampler application including only a subset of the one or more application datasets.

In some implementations, the invention may include a method further comprising receiving an election from a responding one of the selected one or more of the plurality of application recipients to receive further information regarding the applicant, providing the responding one of the selected one or more of the plurality of application recipients with at least an additional portion of the full application, and notifying the applicant of the election and the at least an additional portion of the full application.

In some implementations, the invention may include a method further comprising initiating a sampler application bounceback, the sampler application bounceback indicating that the selected one or more of the plurality of application recipients has not elected to receive at least an additional portion of the full application, and notifying the applicant of the sampler application bounceback.

In some implementations, the invention may include a method wherein the sampler application bounceback resulted from an expiration of a sampler period, wherein the sampler period is a period of time within which the selected one or more of the plurality of application recipients must elect to receive at least an additional portion of the full application. In some implementations, the invention may include a method wherein the sampler application bounceback resulted from the selected one or more of the plurality of application recipients actively indicating no interest in receiving at least an additional portion of the full application.

In some implementations, the invention may include a method wherein the plurality of application recipients are educational institutions. In some implementations, the invention may include a method wherein the educational institutions are undergraduate universities. In some implementations, the invention may include a method wherein a pre-existing business relationship does not exist between one or more of the plurality of application recipients and a provider of the application. In some implementations, the invention may include a method wherein the one or more application datasets is submitted by the applicant. In some implementations, the invention may include a method wherein the one or more application datasets is submitted by a third party. In some implementations, the invention may include a method wherein the third party is associated with the applicant. In some implementations, the invention may include a method wherein the third party is associated with one or more of the plurality of application recipients.

In some implementations, the invention may include a method wherein the plurality of application recipients are prospective employers. In some implementations, the invention may include a method wherein the plurality of application recipients are prospective employees. In some implementations, the invention may include a method wherein a pre-existing business relationship does not exist between the applicant and a provider of the application.

In some implementations, the invention may include a computer readable medium containing computer-executable instructions for providing an interest rating of an applicant in one or more of a plurality of application recipients and an application of the applicant to the one of the plurality of application recipients, the application including one or more application datasets, the instructions operable when executed on a computing device to receive one or more application datasets, provide the applicant with information identifying a plurality of application recipients, from which the applicant may select one or more of the plurality of application recipients to which to apply, allot the applicant one or more tokens, the one or more tokens being associated with a level of interest in one or more of the plurality of application recipients, receive from the applicant a selection of one or more of the plurality of application recipients to which the applicant wishes to apply, receive from the applicant an assignment of a number of the one or more tokens to a particular one of the one or more of the plurality of application recipients, provide the particular one of the one or more of the plurality of application recipients information related to the assignment of the number of the one or more tokens that were assigned by the applicant to the particular one of the one or more of the plurality of application recipients, and provide the application to the selected one or more of the plurality of application recipients.

In some implementations, the invention may include a computer readable medium containing computer-executable instructions, the instructions further operable when executed on a computing device to provide the particular one of the one or more of the plurality of application recipients with the number of the one or more tokens allotted to the applicant. In some implementations, the invention may include a computer readable medium containing computer-executable instructions, the instructions further operable when executed on a computing device to allot the applicant one or more super-tokens, the one or more super-tokens being associated with an enhanced level of interest in one or more of the plurality of application recipients as compared to the one or more tokens, receive from the applicant an assignment of a second number of the one or more super-tokens to a particular one of the one or more of the plurality of application recipients, and provide the particular one of the one or more of the plurality of application recipients information related to the assignment of the second number of the one or more super-tokens that were assigned by the applicant to the particular one of the one or more of the plurality of application recipients.

In some implementations, the invention may include a computer readable medium containing computer-executable instructions, the instructions further operable when executed on a computing device to provide the particular one of the one or more of the plurality of application recipients with the second number of the one or more super-tokens allotted to the applicant. In some implementations, the invention may include a computer readable medium containing computer-executable instructions, the instructions further operable when executed on a computing device to in response to an indication of rejection by the selected one or more of the plurality of application recipients: notify the applicant of the indication of rejection, and return to the applicant the one or more tokens assigned to the selected one of the plurality of application recipients that gave the indication of rejection.

In some implementations, the invention may include a computer readable medium containing computer-executable instructions, wherein the returned one or more tokens may be reassigned by the applicant to another one of the selected one of the plurality of application recipients.

In some implementations, the invention may include a computer readable medium containing computer-executable instructions, wherein the provided application is a sampler application, the sampler application including only a subset of the one or more application datasets.

In some implementations, the invention may include a computer readable medium containing computer-executable instructions, the instructions further operable when executed on a computing device to receive an election from a responding one of the selected one or more of the plurality of application recipients to receive further information regarding the applicant, provide the responding one of the selected one or more of the plurality of application recipients with at least an additional portion of the full application, and notify the applicant of the election and the at least an additional portion of the full application.

In some implementations, the invention may include a computer readable medium containing computer-executable instructions, the instructions further operable when executed on a computing device to initiate a sampler application bounceback, the sampler application bounceback indicating that the selected one or more of the plurality of application recipients has not elected to receive at least an additional portion of the full application, and notify the applicant of the sampler application bounceback.

In some implementations, the invention may include a computer readable medium containing computer-executable instructions, wherein the sampler application bounceback resulted from an expiration of a sampler period, wherein the sampler period is a period of time within which the selected one or more of the plurality of application recipients must elect to receive at least an additional portion of the full application.

In some implementations, the invention may include a computer readable medium containing computer-executable instructions, wherein the sampler application bounceback resulted from the selected one or more of the plurality of application recipients actively indicating no interest in receiving at least an additional portion of the full application. In some implementations, the invention may include a computer readable medium containing computer-executable instructions, wherein the plurality of application recipients are educational institutions. In some implementations, the invention may include a computer readable medium containing computer-executable instructions, wherein the educational institutions are undergraduate universities.

In some implementations, the invention may include a computer readable medium containing computer-executable instructions, wherein the plurality of application recipients are undergraduate universities. In some implementations, the invention may include a computer readable medium containing computer-executable instructions, wherein a pre-existing business relationship does not exist between one or more of the plurality of application recipients and a provider of the application. In some implementations, the invention may include a computer readable medium containing computer-executable instructions, wherein the one or more application datasets is submitted by the applicant. In some implementations, the invention may include a computer readable medium containing computer-executable instructions, wherein the one or more application datasets is submitted by a third party. In some implementations, the invention may include a computer readable medium containing computer-executable instructions, wherein the third party is associated with the applicant.

In some implementations, the invention may include a computer readable medium containing computer-executable instructions, wherein the third party is associated with one or more of the plurality of application recipients. In some implementations, the invention may include a computer readable medium containing computer-executable instructions, wherein the plurality of application recipients are prospective employers. In some implementations, the invention may include a computer readable medium containing computer-executable instructions, wherein the plurality of application recipients are prospective employees. In some implementations, the invention may include a computer readable medium containing computer-executable instructions, wherein a pre-existing business relationship does not exist between the applicant and a provider of the application.

In some implementations, the invention may include a computer readable medium containing computer-executable instructions, the instructions further operable when executed on a computing device to aggregate data associated with the selected one or more of the plurality of application recipients, and present the aggregated data to the applicant.

Various other objects, features, and advantages of the invention will be apparent through the detailed description and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an exemplary illustration of a schematic diagram of a system, according to various implementations of the invention.

FIG. 2 is an exemplary illustration of a schematic diagram of a server, according to various implementations of the invention.

FIG. 3 is an exemplary illustration of a user interface module, according to various implementations of the invention.

FIG. 4 is an exemplary illustration of an administrative module, according to various implementations of the invention.

FIG. 5 is an exemplary illustration of an applicant recipient module, according to various implementations of the invention.

FIG. 6 is an exemplary illustration of an applicant module, according to various implementations of the invention.

FIG. 7 is an exemplary illustration of a third party module, according to various implementations of the invention.

FIG. 8 illustrates a flowchart of user interaction with a system, according to various implementations of the invention.

FIG. 9 illustrates a flowchart of processing a sampler application initiated by the applicant to one or more of the plurality of application recipients, according to various implementations of the invention.

### DETAILED DESCRIPTION

The invention relates to various systems and methods for providing an application service and related features. Various implementations of the invention include one or more hardware and/or software application service modules 202-224 that may receive one or more application datasets from applicants and may transmit the one or more application datasets to one or more of a plurality of application recipients. Application datasets may include data related to an applicant such as, for example, grades, test scores, essays, letters of recommendation, references, and/or other data related to an applicant. In some implementations, the invention may include one or more hardware and/or software modules that may issue to the applicant one or more tokens, wherein the applicant may assign the one or more tokens to one or more of the plurality of application recipients. The assigned one or more tokens may indicate a level of interest by the applicant in the one or more of the plurality of application recipients.

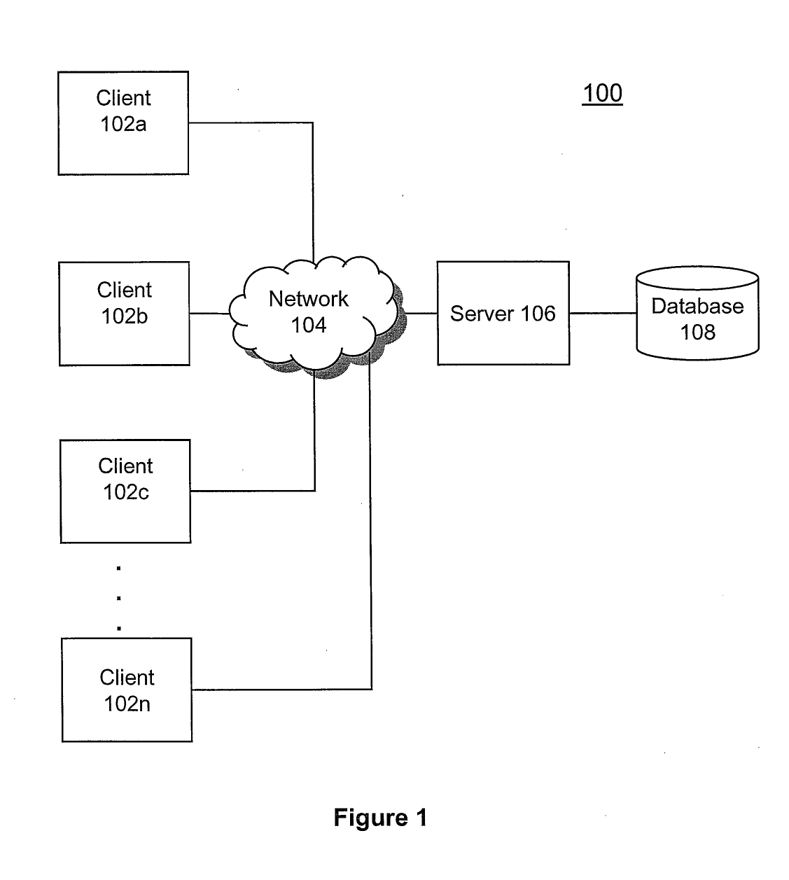

FIG. 1 illustrates an example of a system 100 for providing an application service according to various implementations of the invention. In some implementations, the system 100 may include at least one server 106, which may communicate over a communication path connected via a network 104 to one or more clients (102a, 102b, 102c, . . . 102n). Server 106 may be coupled to at least one database 108 that stores system data, including, for example, the one or more application datasets, applicant information, application recipient information, and/or other system data. As illustrated, client 102 may comprise a client computer, wherein an interface is displayed that enables access to one or more other nodes of the system.

Network 104 may include any one or more of, for instance, the Internet, an intranet, a PAN (Personal Area Network), a LAN (Local Area Network), a WAN (Wide Area Network), a SAN (Storage Area Network), or a MAN (Metropolitan Area Network). Any suitable communications link may be utilized, including any one or more of, for instance, a copper telephone line, a Digital Subscriber Line (DSL) connection, a Digital Data Service (DDS) connection, an Ethernet connection, an Integrated Services Digital Network (ISDN) line, an analog modem connection, a cable modem connection, a wireless data connection, or other connection.

Database 108 may be, include, or interface to, for example, an Oracle™ relational database sold commercially by Oracle Corporation. Other databases, such as Informix™, DB2 (Database 2) or other data storage or query formats, platforms, or resources such as OLAP (On Line Analytical Processing), SQL (Standard Query Language), a SAN (storage area network), Microsoft Access™ or others may also be used, incorporated, or accessed. Other configurations and system architectures may be used. For example, while only one server 106 is illustrated, any number of servers 106 may be utilized. Similarly, any number of clients 102 may be connected to the server 106. Furthermore, although only one database 108 is illustrated, any number of databases 108 may be used.

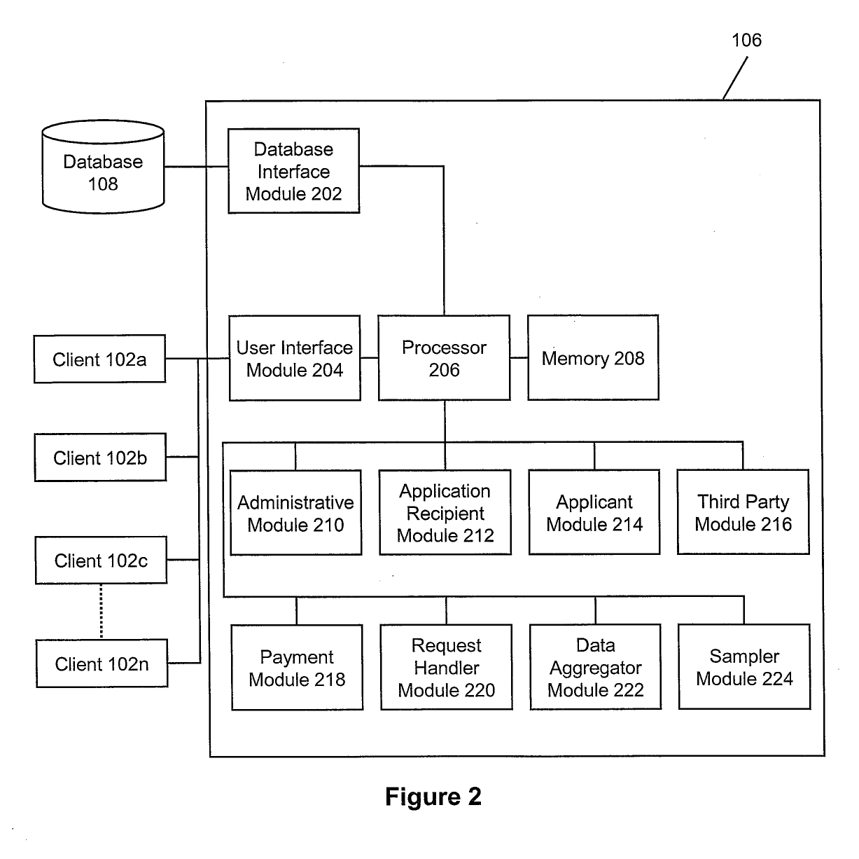

FIG. 2 illustrates an example of a server 106 according to various implementations of the invention. Server 106 may include at least one processor 206 for processing and at least one memory 208 for storing data as it is being processed according to well known techniques. Server 106 may use one or more application service modules. In some implementations, the one or more application service modules may include at least some of the following hardware and/or software modules: a database interface module 202, a user interface module 204, an administrative module 210, an application recipient module 212, an applicant module 214, a third party module 216, a payment module 218, a request handler module 220, a data aggregator module 222, a sampler module 224, and/or other modules.

In some implementations, server 106 may use database interface module 202 to access and/or interface with database 108 to perform database operations such as, for example, insert, retrieve, update, and/or perform other database operations. For example, database 108 may store and retrieve the one or more application datasets using database interface module 202.

In some implementations, user interface module 204 may present the client 102 with a user interface based at least in part on a user accessing the one or more clients. For example, if the user is a high school applicant applying for college, the user interface may include computer implemented forms in which to upload the one or more application datasets, among others. Furthermore, if the user is a college or university that receives an application, user interface module 204 may present the user with a user interface that includes options to download the one or more application datasets, among other functions. As used herein, the term “user” may include any system user including, for example, an applicant, a third party, an application recipient, and/or any other system user. Furthermore, the term “third party” may be any other party relevant to an application other than the applicant or application recipient such as, for example, a high school guidance counselor, an employment service, and/or any other relevant party other than the applicant or application recipient. As used herein, the term “application” may include at least some of the following: the one or more application datasets, aggregated data, third party comments, and/or any other set of information related to the applicant.

In some implementations, server 106 may use administrative module 210 to perform administrative functions. Administrative module 210 may include other hardware and/or software modules for one or more system administrators to perform functions such as, for example, controlling other functions and/or modules, updating the system, entering datasets, controlling access, and/or any other functions.

In some implementations, server 106 may use application recipient module 212 to provide functions to serve the one or more application recipients. Application recipient module 212 may include one or more hardware and/or software modules to provide functions for one of the plurality of application recipients including, for example, controlling other functions and/or modules, handling the one or more application datasets, updating status on an application, reporting data, and/or any other function.

In some implementations, server 106 may use applicant module 214 to provide functions to serve the applicant. Applicant module 214 may include one or more hardware and/or software modules to provide functions to the applicant including, for example, controlling other functions and/or modules, handling datasets for the applicant, handling tokens, reporting data, and/or any other function.

In some implementations, server 106 may use third party module 216 to provide functions to the one or more third parties. Third party module 216 may include one or more hardware and/or software modules to provide functions to the one or more third parties including, for example, controlling other functions and/or modules, handling the one or more application datasets, tracking applicants, reporting data, and/or any other function.

In some implementations, server 106 may use payment module 218 to process payments. Payment module 218 may facilitate payments to the application service. Payments may be made by any user such as, for example, an applicant, one or more third parties, one or more of the plurality of application recipients, and/or any other user. Payments due may include, for example, registration fees, application fees, usage fees for using the system, and/or any other payment due. Furthermore, the application service may accept application fees due to the application recipient on behalf of the application recipient. For example, the system may provide payment services for any application fees charged by one of the plurality of application recipients, if applicable. Payments processed in this manner may be credited to the appropriate one of the plurality of application recipients. Payments may be processed using any number of payment options including, for example, online credit card transactions, online payment services (such as Paypal™, Google Checkout™, etc.), online check, and/or any other payment options. While exemplified using online payment options, any other payment option may be processed. For example, the system of the invention may accept wire transfers, electronic fund transfers, credit card payments, personal check or money order, whereby payment module 410 may record the applicant's intent to pay using these methods and upon receipt of payment, the applicant account may be credited. Other mechanisms for handling payments may be used as would be appreciated. Furthermore, the invention may use “pay-as-you-go” payment plans, wherein a pre-existing contract or business relationship between the application service and the user is unnecessary. Advantages of the pay-as-you-go system include the ability by application recipients, for example, to rapidly increase the pool of applicants without undergoing lengthy contract negotiations. Instead, an application recipient (e.g., a college, employer, etc.) may receive increased numbers of applicants by using the application service for a month, for example, without the need to enter into a longer-term contract. The invention may also use prepaid subscription services, wherein a pre-existing contract or business relationship between the application and the user is necessary.

In some implementations, server 106 may use request handler module 220 to handle requests made by users. In some implementations, request handler module 220 may handle requests made by any user. Requests may be made by any user to any other user, any user to the system, the system to any user, and/or any other request combination. Requests may include, for example, an update status request, a request to send additional one or more application datasets, a request to cancel an application, interview request, and/or any other request. If a request is made by one user to another user, for example, the request handler module may notify the appropriate user of the request. Notifications may be accomplished using any technique including, for example, electronic mail, website posting, U.S. mail, and/or any other technique.

In some implementations, data aggregator module 222 may aggregate data related to the application from a variety of sources including, for example, blogs, message boards, chat sessions, forums, and/or any or source. As used herein, data related to the application may include any data related to the applicant, third party, application recipient, and/or any other data related to the application. For example, data aggregator module 222 may provide the applicant and/or third party with information related to one or more of the plurality of application recipients such as, for example, everyday life on-campus, student body makeup, student ratings of professors, and/or any other information related to one or more of the plurality of application recipients. By way of another example, the application service may provide one or more of the plurality of application recipients with information concerning the applicant such as, for example, hobbies, school environment preferences (e.g., large school, small school, city school, rural school, etc.), and/or any other information concerning the applicant. Aggregated data may be provided in one or more reports by various report modules disclosed herein elsewhere in the specification. Data aggregator module 222 may also store aggregated data in database 108, categorized by the user to which data is aggregated. For example, data aggregator module 222 may provide a high school student with one or more websites and/or sections of websites that present aggregated data about one or more colleges or universities. More particularly, the high school student, for example, may be presented with links to blogs associated with each college or university in which data has been aggregated. Data may be aggregated using any technique such as, for example, online web search, a system user entering aggregated data into the system, and/or other technique. Although exemplified herein as a college application process, the application service may serve other application processes and, as such, the foregoing examples are not limiting.

In some implementations, sampler module 224 may present one or more of the plurality of application recipients with one or more sampler applications. The one or more of the plurality of application recipients presented with a sampler application may include application recipients such as, for example, those that do not have a pre-existing business relationship with the application service, those that have registered with the application service in the past, those that have subscription-based services (those that do have a pre-existing business relationship), and/or other application recipient. One or more of the plurality of application recipients that were presented with a sampler application may fully “purchase” any one of the one or more applications on an ad-hoc basis. Purchasing sampler applications may include other payment options, such as, for example, on a subscription basis. Subscriptions may include, for example, receiving full applications of a set number of sampler applications, receiving full applications of sampler applications for a specified period of time, and/or any other subscription.

One or more of the plurality of application recipients may be identified for presenting a sampler application using any identification technique such as, for example, selecting from a list of registered application recipients, one or more users identifying application recipients and entering them into the system, the applicant selecting one of the plurality of application recipients, and/or any other technique.

In some implementations, sampler module 224 may include a sampler period, in which the sampler application may expire. The sampler period may include any length of time such as, for example, one day, two days, one week, one month, and/or other length of time. Upon sampler period expiration, the sampler application may be withdrawn and may be considered rejected whereupon a bounceback indication may be initiated. If an applicant initiated the expired sampler application, the applicant may be notified that the one or more of the plurality of application recipients that was presented with the sampler application has not elected to purchase the sampler application. One or more of the plurality of application recipients that were presented with the sampler application may respond with a decline to view response, which may initiate a bounceback notification. A bounceback notification may represent refusal by the one or more of the plurality of application recipients that was presented with a sampler application. Thus, a bounceback may be initiated by sample period expiration and/or by active decline to view the sampler application. Furthermore, if one or more tokens and/or super-tokens were assigned to the sampled one or more of the plurality application recipients, then the one or more tokens and/or super-tokens may be refunded to the applicant. The foregoing example is exemplary only and is not limiting. For example, the one or more tokens and/or super-tokens that was assigned to the sampled one of the plurality of application recipients may not be refunded to the applicant.

Sampler module 224 may use screening techniques to present one or more of the plurality of application recipients with one or more applicants who may be a good match. For example, sampler module 224 may access any one of the report modules described herein elsewhere to gather statistics regarding a college or university that has never used the application service. Gathered statistics may include, for example, average grade point averages (GPA) of admitted students, average test scores of admitted students, geographical composition of the student body (regions of the country from which the students originate), and/or other gathered statistics. Sampler module 224 may screen one or more applicants who have used the application service to identify candidates who may be a good match with the college or university selected to be presented with a sampler application based at least in part on the gathered statistics. A sampler application from the identified one or more applicants may be forwarded to a college or university, wherein the college or university may elect to purchase one or more complete applications of the identified one or more applicants. By way of further example, a college or university that has a range of GPA for admitted students of 3.6-3.8 may be forwarded a sampler application of one or more applicants with a GPA of 3.7.

The foregoing examples are illustrative only and should not be limiting. For example, the application recipient presented with a sampler application may be an employer. Furthermore, sampler module 224 may omit the screening process and forward one or more of the plurality of application recipients any sampler application. Sampler module 224 may also forward a plurality of sampler applications that are at least grouped by statistic or combination of any statistic (e.g., forwarded sampler applications are grouped according to GPA, wherein a first group has a GPA from 2.5-3.0, a second group has a GPA from 3.01-3.5, etc.).

Sampler module 224 may also enable “reverse sampler presentment” whereby one or more of the plurality of application recipients may recruit one or more applicants based on reports generated by modules disclosed herein elsewhere. For example, a college or university may select one or more students in which to entice into applying to the college or university. Other implementations are contemplated, as would be appreciated by those skilled in the art.

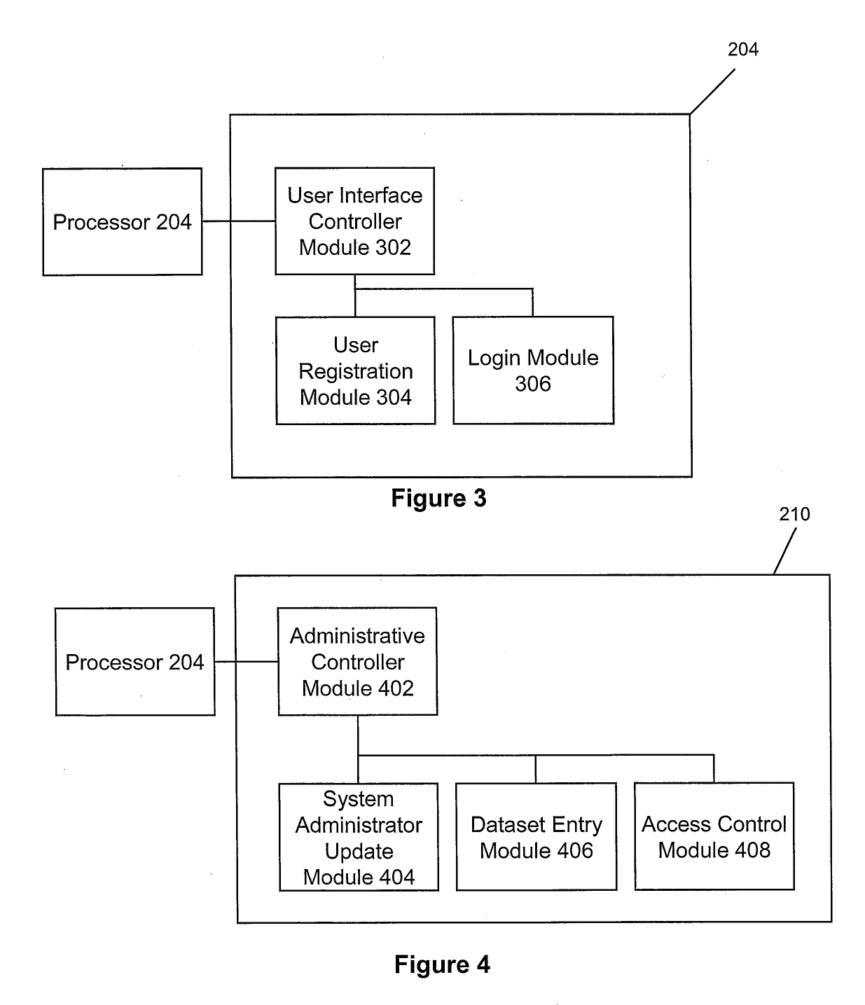

FIG. 3 illustrates an example user interface module 204 according to various implementations of the invention. In some implementations, user interface module 204 may include one or more hardware and/or software modules including, for example, a user interface controller module 302, a user registration module 304, a login module 306, and/or any other module. User interface controller module 302 may determine the type of interface to present the user based at least in part on the user's identity. User interface controller module 302 may use user registration module 304 to present the user with computer implemented input forms, for example, in which to register to access and/or use the system. Different types of users may be presented with different input forms. For example, if the user is a high school applicant, the user may be presented with input forms with input fields relating to the applicant's name, age, high school, and/or any other input fields. If the user is a college or university receiving an application, for example, the user may be presented with input forms with input fields such as, for example, specifying whether the school is public or private, the size of the school, authorized university personnel to access the system, and/or any other input fields. In some implementations, registration module 304 may assign the user a unique identifier that is used by the system to identify the user upon registration.

In some implementations, user interface controller module 302 may use login module 306 to authenticate the user accessing the system according to methods well known in the art. Such methods may include, for example, use of a shared secret (e.g., a username, password, etc.), authentication based on an input/output device such as a USB device, biometric identification, and/or any other authentication method.

FIG. 4 illustrates an example of administrative module 210 according to various implementations of the invention. Administrative module 210 may include one or more hardware and/or software modules such as, for example, an administrative controller module 402, a system administrator module 404, a dataset entry module 406, an access control module 408, and/or any other module. Administrative controller module 402 may use system administrator module 404 to perform system functions including, for example, updating system modules, viewing system performance, configuring the system, and/or any other system functions. Administrative controller module 402 may use dataset entry module 406 to enter data into the system. For example, the user (e.g., the applicant, third party, applicant recipient, etc.) may provide data that may be entered by system users. Such data may include, for example, official transcripts mailed by a high school guidance counselor, test results from a standardized testing agency, and/or any other data that may be entered by one or more system users of the application service. As used herein, “system users” includes any user working on behalf of the application service.

In response to a user request to control access, administrative controller module 402 may use access control module 408 to set access permissions to data related to the application. For example, the applicant may provide a plurality of access levels to the third party regarding the one or more datasets. As used herein, “access levels” indicate the amount of access, or permission, a user has to any portion of the application. Access levels may include, for example, read-only, update, insert (create new), and/or any other access level. Access levels may be set on the entire application and/or individual parts of the application. By way of example, a high school applicant may give a high school guidance counselor access to insert one or more application datasets (such as letters of recommendation) to be included with the application, among giving other access controls.

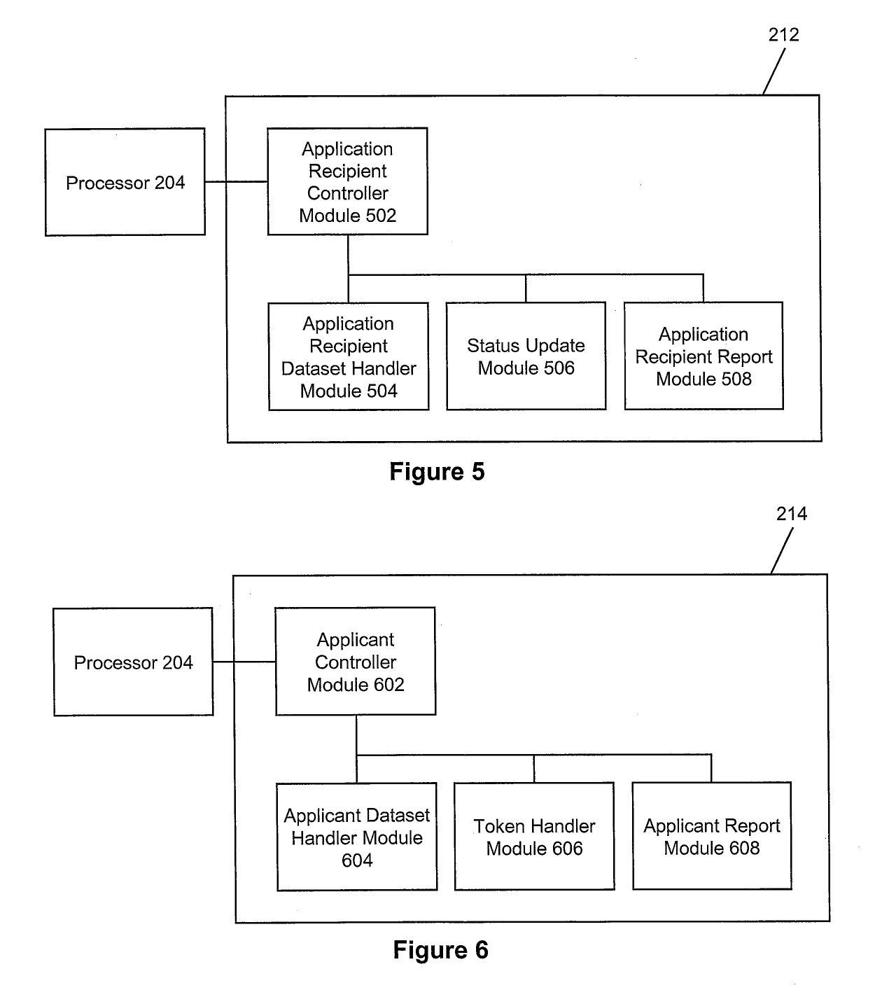

FIG. 5 illustrates an example application recipient module 212 according to various implementations of the invention. In some implementations, application recipient module 212 may include one or more hardware and/or software modules such as, for example, application recipient controller module 502, application recipient dataset handler module 504, status update module 506, application recipient report module 508, and/or any other modules. Applicant recipient controller module 502 may use application recipient dataset handler module 504 to provide interaction with and/or interface to the one or more application datasets including, for example, receive, download, process, and/or other interactions with the one or more application datasets. The application recipient dataset handler module 504 may notify the one of the plurality of application recipients when the applicant has selected the one of the plurality of application recipients and has uploaded the one or more datasets.

Application recipient controller module 502 may use status update module 506 to update application status. Application status may include status indicators such as, for example, received, processing, considering, and/or any other status indicators. Status update module 506 may notify the applicant, the one or more third party, and/or any other user of the status update. Application recipient controller module 502 may use application recipient report module 508 to generate one or more reports for one or more of the plurality of application recipients. Reports may include information related to the applicant based on any grouping of applicants such as, for example, a particular applicant, applicants based on a locality, applicants nationwide, and/or any other grouping of applicants.

Reported application information may include any information such as, for example, test scores, grades, prior experience, and/or any other application information. Furthermore, reported application information may include past statistics relating to prior offers of acceptance and actual acceptance of prior offers in order to predict whether the applicant will accept an offer. For example, application recipients that are colleges or universities may view one or more reports relating to past applicants with certain application characteristics such as test scores, grades, geographic, and/or other characteristics that have been offered admission to the college or university and have actually matriculated. Such reporting information may identify which applicant may accept an offer of admission, thereby streamlining the admissions process. Any other statistic or method may be used to predict whether an applicant will accept an offer.

FIG. 6 illustrates an example applicant module 214 according to various implementations of the invention. Applicant module 214 may include one or more hardware and/or software modules such as, for example, an applicant controller module 602, an applicant dataset handler module 604, a token handler module 606, an applicant report module 608, and/or other modules. Applicant controller module 602 may, for example, control modules and functions related to interaction by the applicant with the system. Applicant controller module 602 may use applicant dataset handler module 604 to handle the one or more application datasets from the applicant including, for example, receiving, processing, storing, and/or performing any other application dataset handling function on the one or more application datasets.

Applicant controller module 602 may use token handler module 606 to perform functions related to applicant tokens, including, for example, issuing one or more tokens, keeping track of assigned tokens, returning tokens, and/or any other function related to applicant tokens. The one or more tokens may be used by the applicant to indicate a level of interest of the applicant in one or more of the plurality of application recipients. In some implementations, a higher proportion of tokens assigned by the applicant versus tokens issued to the applicant may indicate a higher level of interest by the applicant in one of the plurality of application recipients. For example, the applicant may assign a first number of tokens to a first application recipient and second number of tokens to a second application recipient and no tokens to a third application recipient. If the applicant has a higher level of interest in the first application recipient than the second application recipient, the applicant may assign tokens among the two so that: 1) the first number is marginally greater than the second number, 2) the first number is slightly greater than the second number, or 3) the first number is significantly greater than the second number. If the applicant has a similar level of interest in the first application recipient as compared with the second application recipient, the applicant may assign an equal number of tokens among the two. In each case, the sum of the tokens assigned to pending applications may be less than the number of tokens issued to or allocated to the applicant. By further example, if an applicant is issued by the application service 100 tokens, 70 of which are assigned to a first application recipient and 20 of which are assigned to a second application recipient, this assignment may indicate a greater level of interest by the applicant in the first application recipient as compared to the second application recipient.

Information regarding the number of tokens assigned to the application and/or information regarding the number of tokens assigned or allocated to the applicant may accompany the application or otherwise be provided to the application recipient to indicate a level of relative interest of the applicant in the application recipient. In the example provided above, the first application recipient may receive information regarding the 70 tokens assigned to the first application (as an absolute number) or may receive information regarding the 70 tokens along with the total number of tokens allocated to the applicant (as a relative number). In some implementations, this may be expressed as a ratio to application recipient (i.e., 70%, etc.) This information may be used by the application recipient in processing the application accordingly as the information may be used to indicate a greater likelihood of a favorable response by the applicant to an offer by the first application recipient.

The invention also contemplates the reverse indication, whereby a lower proportion of assigned tokens versus issued tokens indicate a greater level of interest (a higher level of interest in the second application recipient in the foregoing example). The foregoing examples are illustrative only and should not be limiting. For example, any number of tokens may be issued to the applicant.

In some implementations, token handler module 606 may issue one or more “super-tokens.” The one or more super-tokens may indicate a special token that may indicate a heightened level of interest by the applicant in one or more of the plurality of application recipients as compared to the one or more tokens. The number of super-tokens issued to the applicant may be fewer than the number of the one or more tokens issued to the applicant. Furthermore, different types of super-tokens are contemplated. For example, one or more of a type of super-token called a “birdie” super-token may be issued to the applicant. For example, an applicant may be issued 100 tokens and one birdie, wherein the one birdie may indicate a heightened level of interest by the applicant. The one or more of the plurality of application recipients that receive the birdie may react accordingly, because the applicant has indicated a heightened level of interest.

Multiple scenarios are contemplated. For example, an applicant may assign 70 tokens to a first application recipient, 20 tokens to a second application recipient, and zero tokens but one birdie to a third application recipient. The one birdie may indicate to the third application recipient a heightened level of interest despite receiving zero tokens. In another example, the third application recipient may receive the one birdie as in the foregoing example, but receive 10 tokens as well. In yet another example, the applicant may use the birdie to indicate a tie breaker among one or more of the plurality of application recipients. For example, the applicant may assign 40 tokens to a first application recipient, 40 tokens to a second application recipient, and 20 tokens to a third application recipient. If the applicant assigns the birdie to the first applicant, for example, this may indicate a preference of the applicant for the first application recipient. In yet another example, the birdie may be equated to an equivalent number of tokens. For example, one birdie may be equivalent in value to 50 (or any other number of) tokens. As such, the birdie may be exchanged for an equivalent number of tokens. The foregoing examples are exemplary only and are not limiting. Any number of super-tokens, birdies, and/or other super-tokens may be issued to the applicant. Furthermore, the value of each super-token, birdie, and/or other type of super-token may be assessed using any technique such as, for example, a quantitative valuation (i.e., equated to a number of tokens), a qualitative valuation, and/or other technique.

Although exemplified using a fixed number of tokens and/or super-tokens, the token handler module 606 may issue any number of tokens and/or super-tokens including, for example, a variable number of tokens and/or super-tokens, a randomly generated number of tokens and/or super-tokens, a user-requested number of tokens and/or super-tokens, and/or any other number of tokens and/or super-tokens. Furthermore, although a proportion of tokens and/or super-tokens assigned versus tokens and/or super-tokens issued is exemplified, a proportion of tokens and/or super-tokens issued versus tokens and/or super-tokens assigned may be used. The invention may also use an absolute number of assigned tokens and/or super-tokens in addition to or instead of a proportion of assigned tokens and/or super-tokens to indicate level of interest. The invention may also issue different applicants a different number of tokens and/or super-tokens.

Furthermore, token handler module 606 may also “refund” tokens and/or super-tokens to the applicant when tokens and/or super-tokens were assigned by the applicant to one of the plurality of application recipients that rejected the applicant. The applicant may reuse the refunded tokens and/or super-tokens to assign to any one of the remaining one of the plurality of application recipients in which the applicant has applied (or any other one of the plurality of application recipients). In this manner, the “next in line” one of the plurality of application recipients may be notified of an increased level of interest by the applicant in the one of the plurality of application recipients as a result of being rejected by the applicant's original top choice. This aspect of the invention may enhance offer acceptance rates during later stages of an application process. It should be noted that the foregoing example should not be limiting because the invention may also use a system wherein no tokens and/or super-tokens may be refunded.

Applicant controller module 602 may use applicant report module 608 to generate one or more reports for the applicant such as, for example, status update reports, application dataset reports, account balance reports, payment history reports, token reports, suggestions and/or any other reports for the applicant. Suggestions may include one or more of the plurality of application recipients in which the applicant may be interested based on any factor including, for example, applicant preferences, test scores, grades, and/or any other factor. Suggestions may also be based on the likelihood of acceptance based on the one or more datasets, for example. The one or more reports may be provided to the applicant using any output format such as, for example, the website using any web technology (such as a Hyper Text Markup Language table), word processing document, eXtensible Markup Language document (XML), and/or any other output format. The report may be accessed by viewing, printing, storing on local memory, and/or any other access method.

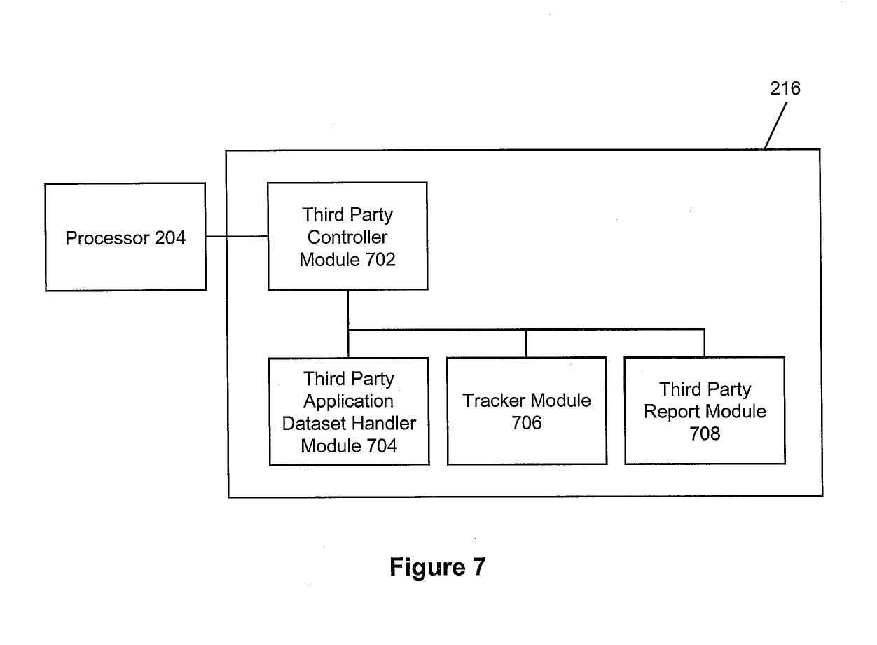

FIG. 7 illustrates an example third party module 216 according to various implementations of the invention. In some implementations, third party module 216 may include other hardware and/or software modules such as, for example, third party controller module 702, third party application dataset handler module 704, tracker module 706, third party report module 708, and/or other modules. A third party may include, for example, a high school guidance counselor acting on behalf of a college applicant, an employment service acting on behalf of a job seeker, and/or any other third party acting on behalf of the applicant and/or one of the plurality of application recipients.

For example, third party controller module 702 may use third party application dataset handler module 704 to provide functions to the one or more third parties to handle application datasets on behalf of the applicant. Third party controller module 702 may check, via processor 204 one or more access levels set by the applicant through access control module 408. Third party controller module 702 may enable the third party to handle the one or more application datasets accordingly. Third party controller module 702 may use tracker module 706 to provide functions to track the applicant. Tracking may include, for example, identifying applicants for which the third party will act, listing applicants for which the third party will act, and/or any other tracking functions. Access to track the applicant may be restricted, in which case the third party will not be able to track the applicant unless the applicant sets such access through access control module 408.

In response to a request to generate one or more reports, third party controller module 702 may use third party report module 708 to generate the one or more reports for the third party. The one or more reports may include, for example, applicant progress reports, applicant summary reports, and/or any other report. The one or more reports may be provided to the third party using any output format such as, for example, the website using any web technology (such as a Hyper Text Markup Language table), word processing document, eXtensible Markup Language document (XML), and/or any other output format. The one or more reports may be accessed by viewing, printing, storing on local memory, and/or any other access method. The one or more reports may be used by third parties to monitor, for example, successful applications in order to assist the third party in helping future applicants. For example, a high school guidance counselor may use the one or more reports to analyze past applicant success rates based on the one or more application datasets (e.g., grades, test scores, etc.) and use that data to make recommendations to future applicants. These recommendations may increase the overall efficiency of the application process by reducing the number of applications that would not likely lead to acceptance, for example.

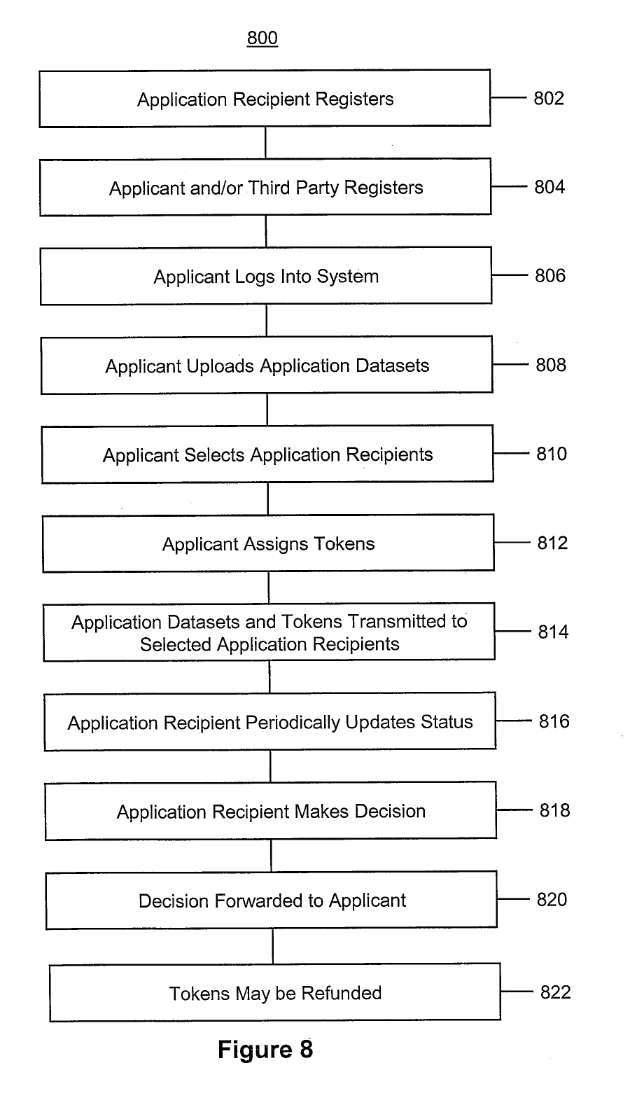

FIG. 8 illustrates a flowchart of processing 800 for user interaction with system 100. The described operations may be accomplished using some or all of the system components described in detail above and, in some implementations, various operations may be performed in different sequences. In other implementations, additional operations may be performed along with some or all of the operations shown in FIG. 8. In yet other implementations, one or more operations may be performed simultaneously. Accordingly, the operations described are exemplary in nature and, as such, should not be viewed as limiting.

In an operation 802, one or more of a plurality of application recipients may register to use the application service. In an operation 804, one or more applicants and/or one or more third parties may register to use the system. The one or more third parties may be related to at least one of the one or more applicants. For example, the one or more third parties may be high school guidance counselors acting on behalf of the one or more applicants. In an operation 806, the applicant may logon to the system using at least some of the information used during the registration process, wherein the applicant may be authenticated. In an operation 808, the application service may receive from the applicant one or more application datasets, whereby the applicant may upload the one or more datasets through an interface (e.g., a website) of the application service. The one or more application datasets may include, for example, grades, test scores, essays, letters of recommendation, references, and/or other data related to an applicant.

In an operation 810, the applicant may be presented with the one or more of a plurality of application recipients and the applicant may make a selection of at least one of the one or more of a plurality of application recipients. The list of the presented one or more of a plurality of application recipients may be derived from a list of registered one or more of a plurality of application recipients or derived using any other method such as, for example, identification by the application service as an application recipient. In an operation 812, the applicant may be issued one or more tokens by the application service, wherein the tokens may be assigned by the applicant to the one or more of a plurality of application recipients. The tokens may indicate a level of interest in the one or more of a plurality of application recipients in which the tokens were assigned.

In an operation 814, the one or more application datasets may be forwarded to the selected one of a plurality of application recipients. The selected one of a plurality of application recipients may be forwarded a number of tokens assigned by the applicant and/or the number of tokens issued to the applicant by the application service. In an operation 816, the selected one of a plurality of application recipients may periodically update application status, wherein the applicant and/or one or more third parties may be notified of such update. In an operation 818, the selected one of a plurality of application recipients may make a decision and may update the application service with the decision. In an operation 820, the decision may be forwarded to the applicant and/or the one or more third parties. In an operation 820, if the decision is a rejection notice, then the assigned tokens may be refunded to the applicant, wherein the applicant may re-assign the refunded tokens to another one of a plurality of application recipients.

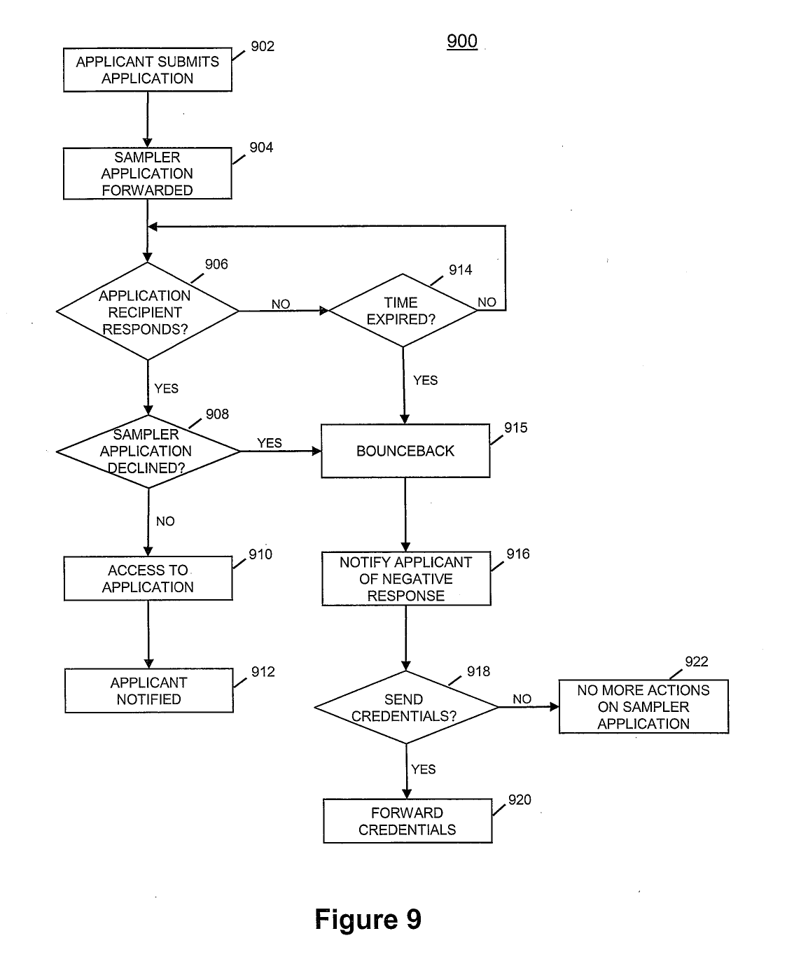

FIG. 9 illustrates a flowchart of processing 900 of processing a sampler application initiated by the applicant to one or more of the plurality of application recipients, according to an aspect of the invention. The described operations may be accomplished using some or all of the system components described in detail above and, in some implementations, various operations may be performed in different sequences. In other implementations, additional operations may be performed along with some or all of the operations shown in FIG. 9. In yet other implementations, one or more operations may be performed simultaneously. Accordingly, the operations described are exemplary in nature and, as such, should not be viewed as limiting.

In an operation 902, an applicant may complete and submit an application to the application service and may select an application recipient to receive the application. In an operation 904, the selected application recipient may be notified of the selection and may be presented with a sampler application, containing at least some portions of the full application.

If in an operation 906 the selected application recipient responds to the sampler application notification, then processing may proceed to an operation 908. If in operation 908, the selected application recipient declines the sampler application, then processing may proceed to an operation 915, wherein a bounceback is initiated. A bounceback may be an indication that the selected application recipient has not elected to receive at least an additional portion of the full application.

Processing may proceed to an operation 916, wherein the applicant may be notified of the negative response, any application fees paid may be returned to the applicant, and any tokens and/or super-tokens assigned may be refunded. Processing may then proceed to an operation 918, wherein if the applicant elects to send credentials to the selected application recipient despite the negative response, then processing may proceed to an operation 920, wherein the credentials of the applicant are sent to the application recipient. Returning to operation 918, if the applicant chooses not to send credentials, then processing may proceed to an operation 922, wherein no further action on the sampler application may be taken. As used herein “credentials” may include the one or more application datasets and/or any other application information.

Returning to operation 908, if the selected application recipient indicates an interest in receiving at least an additional portion of the full application, then processing may proceed to an operation 910, wherein the selected application recipient may log onto the system, be granted access to at least an additional portion of the full application, and have any fees due to the application recipient by the applicant queued for disbursal. Processing may then proceed to an operation 912, wherein the applicant may be notified and the account of the applicant may be updated accordingly.

Returning to operation 906, if the selected application recipient has not responded to the sampler application notification, then processing may proceed to an operation 914, wherein if the time to respond (“the sampler period”) to the sampler application has not expired, then processing may return to operation 906 (to await a response by the selected application recipient).

Returning to operation 914, if the time to respond to the sampler application expired, then processing may proceed to operation 915, wherein a bounceback is initiated. Therefore, a bounceback may be initiated by failure of the selected application recipient to respond before the sample period has expired or by an express indication of no desire to view at least an additional portion of the full application. Processing may proceed to operation 916, wherein the applicant may notified of the negative response, any application fees paid may be returned to the applicant, and any tokens and/or super-tokens assigned may be refunded. Processing may then proceed to operation 918, wherein if the applicant elects to send credentials to the application recipient despite the negative response, then processing may proceed to operation 920, wherein the credentials of the applicant may be to the application recipient. Returning to operation 918, if the applicant chooses not to send credentials, then processing may proceed to an operation 922, wherein no further action on the sampler application may be taken. Although initiation of the sampler application process by the user is exemplified herein, the invention may the sampler application process to be initiated by any technique such as, for example, by another user, without user intervention, and/or other technique.

In some implementations the one or more servers may provide a website accessed by the one or more clients. The website may be generated through the one or more user interface modules using the one or more application service modules running on the one or more servers.

Various functions, components, and modules may be restricted to certain sets of users as appropriate. For example parts of the system such as, for example, components, modules, functions, and/or parts of the system that affect the administration of the system may be available only to system users.

The invention contemplates the ability of the applicant, one or more third parties, one of the plurality of application recipients, and/or other user of the system to use the application service throughout different application periods. For example, a high school student may use the system of the invention to apply during different periods such as for the Fall 2008 entering class and again for the Fall 2009 entering class. The system of the invention may reset the number of tokens (and any other application information) issued to the applicant for each period.

It should be noted that the selected application recipient may be registered with the application service or have no pre-existing relationship with the application service. If there is no pre-existing relationship with the application service, the selected application recipient may register at any time during the application process.

Furthermore, although primarily described using a high school student applying for college as the applicant, a high school guidance counselor as the one or more third party, and a college or university application recipient, the invention may be used in many other application setting as well. For example, the applicant may be a job seeker applying for jobs, the one or more third party may be an employment service worker, and the one or more of the plurality of application recipients may be employers recruiting employees. Other examples are contemplated, as would be apparent to those skilled in the art.

Other implementations, uses and advantages of the invention will be apparent to those skilled in the art from consideration of the specification and practice of the invention disclosed herein. The specification should be considered exemplary only.

What is claimed is:

1. A method for providing a sampler application of an applicant to one of a plurality of application recipients, the sampler application including only a portion of a full application and not the full application, the full application including one or more application datasets, the method comprising:
receiving one or more application datasets;
providing the applicant with information identifying a plurality of application recipients, from which the applicant may select one or more of the plurality of application recipients to which to apply;
receiving from the applicant a selection of one or more of the plurality of application recipients to which the applicant wishes to apply; and
providing the selected one or more of the plurality of application recipients the sampler application.

2. The method of claim 1, further comprising:
receiving an election from a responding one of the selected one or more of the plurality of application recipients to receive further information regarding the applicant;
providing the responding one of the selected one or more of the plurality of application recipients with at least an additional portion of the full application; and
notifying the applicant of the election and the provision of the at least an additional portion of the full application.

3. The method of claim 1, further comprising:
initiating a sampler application bounceback, the sampler application bounceback indicating that the selected one or more of the plurality of application recipients has not elected to receive at least an additional portion of the full version of the sampler application; and
notifying the applicant of the sampler application bounceback.

4. The method of claim 1, further comprising:
allotting the applicant one or more tokens, the one or more tokens being associated with a level of interest in one or more of the plurality of application recipients;
receiving from the applicant an assignment of a number of the one or more tokens to a particular one of the one or more of the plurality of application recipients; and
providing the particular one of the one or more of the plurality of application recipients information related to the assignment of the number of the one or more tokens that were assigned by the applicant to the particular one of the one or more of the plurality of application recipients.

5. The method of claim 4, further comprising:
providing the particular one of the one or more of the plurality of application recipients with the number of the one or more tokens allotted to the applicant.

6. The method of claim 1, wherein the plurality of application recipients are undergraduate universities.

7. The method of claim 1, wherein a pre-existing business relationship does not exist between one or more of the plurality of application recipients and a provider of the sampler application.

8. A computer readable medium containing computer-executable instructions for providing a sampler application of an applicant to one of a plurality of application recipients, the sampler application including only a portion of a full application and not the full application, the full application including one or more application datasets, the instructions operable when executed on a computing device to:
receive one or more application datasets;
provide the applicant with information identifying a plurality of application recipients, from which the applicant may select one or more of the plurality of application recipients to which to apply;
receive from the applicant a selection of one or more of the plurality of application recipients to which the applicant wishes to apply; and
provide the selected one or more of the plurality of application recipients the sampler application.

9. The computer readable medium of claim 8, the instructions further operable when executed on a computing device to:
receive an election from a responding one of the selected one or more of the plurality of application recipients to receive further information regarding the applicant;
provide the responding one of the selected one or more of the plurality of application recipients with at least an additional portion of the full application; and
notify the applicant of the election and the provision of the at least an additional portion of the full application.

10. The computer readable medium of claim 8, the instructions further operable when executed on a computing device to:
initiate a sampler application bounceback, the sampler application bounceback indicating that the selected one or more of the plurality of application recipients has not elected to receive at least an additional portion of the full version of the sampler application; and
notify the applicant of the sampler application bounceback.

11. The computer readable medium of claim 8, the instructions further operable when executed on a computing device to:
allot the applicant one or more tokens, the one or more tokens being associated with a level of interest in one or more of the plurality of application recipients;
receive from the applicant an assignment of a number of the one or more tokens to a particular one of the one or more of the plurality of application recipients; and
provide the particular one of the one or more of the plurality of application recipients information related to the assignment of the number of the one or more tokens that were assigned by the applicant to the particular one of the one or more of the plurality of application recipients.

12. The computer readable medium of claim 11, the instructions further operable when executed on a computing device to:
provide the particular one of the one or more of the plurality of application recipients with the number of the one or more tokens allotted to the applicant.

13. The computer readable medium of claim 8, wherein a pre-existing business relationship does not exist between one or more of the plurality of application recipients and a provider of the sampler application.

14. A method for providing an interest rating of an applicant in one or more of a plurality of application recipients and an application of the applicant to the one of the plurality of application recipients, the application including one or more application datasets, the method comprising:
receiving one or more application datasets;
providing the applicant with information identifying a plurality of application recipients, from which the applicant may select one or more of the plurality of application recipients to which to apply;
allotting the applicant one or more tokens, the one or more tokens being associated with a level of interest in one or more of the plurality of application recipients;
receiving from the applicant a selection of one or more of the plurality of application recipients to which the applicant wishes to apply;
receiving from the applicant an assignment of a number of the one or more tokens to a particular one of the one or more of the plurality of application recipients;
providing the particular one of the one or more of the plurality of application recipients information related to the assignment of the number of the one or more tokens that were assigned by the applicant to the particular one of the one or more of the plurality of application recipients; and
providing the application to the selected one or more of the plurality of application recipients.

15. The method of claim 14, further comprising:
providing the particular one of the one or more of the plurality of application recipients with the number of the one or more tokens allotted to the applicant.

16. The method of claim 14, wherein the provided application is a sampler application, the sampler application including only a portion of a full application and not the full application, the full application including one or more application datasets.

17. The method of claim 16, further comprising:
receiving an election from a responding one of the selected one or more of the plurality of application recipients to receive further information regarding the applicant;
providing the responding one of the selected one or more of the plurality of application recipients with at least an additional portion of the full application; and
notifying the applicant of the election and the at least an additional portion of the full application.

18. The method of claim 16, further comprising:
initiating a sampler application bounceback, the sampler application bounceback indicating that the selected one or more of the plurality of application recipients has not elected to receive at least an additional portion of the full application; and
notifying the applicant of the sampler application bounceback.

19. The method of claim 14, wherein the plurality of application recipients are undergraduate universities.

20. The method of claim 14, wherein a pre-existing business relationship does not exist between one or more of the plurality of application recipients and a provider of the application.

21. A computer readable medium containing computer-executable instructions for providing an interest rating of an applicant in one or more of a plurality of application recipients and an application of the applicant to the one of the plurality of application recipients, the application including one or more application datasets, the instructions operable when executed on a computing device to:
receive one or more application datasets;
provide the applicant with information identifying a plurality of application recipients, from which the applicant may select one or more of the plurality of application recipients to which to apply;
allot the applicant one or more tokens, the one or more tokens being associated with a level of interest in one or more of the plurality of application recipients;
receive from the applicant a selection of one or more of the plurality of application recipients to which the applicant wishes to apply;
receive from the applicant an assignment of a number of the one or more tokens to a particular one of the one or more of the plurality of application recipients;
provide the particular one of the one or more of the plurality of application recipients information related to the assignment of the number of the one or more tokens that were assigned by the applicant to the particular one of the one or more of the plurality of application recipients; and
provide the application to the selected one or more of the plurality of application recipients.

22. The computer readable medium of claim 21, the instructions further operable when executed on a computing device to:
provide the particular one of the one or more of the plurality of application recipients with the number of the one or more tokens allotted to the applicant.

23. The computer readable medium of claim 21, wherein the provided application is a sampler application, the sampler application including only a portion of a full application and not the full application, the full application including one or more application datasets.

24. The computer readable medium of claim 23, the instructions further operable when executed on a computing device to:
receive an election from a responding one of the selected one or more of the plurality of application recipients to receive further information regarding the applicant;
provide the responding one of the selected one or more of the plurality of application recipients with at least an additional portion of the full application; and
notify the applicant of the election and the at least an additional portion of the full application.

25. The computer readable medium of claim 23, the instructions further operable when executed on a computing device to:
initiate a sampler application bounceback, the sampler application bounceback indicating that the selected one or more of the plurality of application recipients has not elected to receive at least an additional portion of the full application; and
notify the applicant of the sampler application bounceback.
